(19) United States
(12) Patent Application Publication
(10) Pub. No.: US 2010/0082379 A1
(43) Pub. Date: Apr. 1, 2010

(54) INFERENTIAL BUSINESS PROCESS MONITORING

(75) Inventors: Allen V.C. Chan, Markham (CA); Phil S. Coulthard, Aurora (CA); Hans-Arno Jacobsen, Toronto (CA); Helena Litani, Thornhill (CA); Vinod Muthusamy, Toronto (CA); Julie F. Waterhouse, Markham (CA)

Correspondence Address: CANTOR COLBURN LLP - IBM RSW, 20 Church Street, 22nd Floor, Hartford, CT, 06103, US

(73) Assignee: International Business Machines Corporation, Armonk, NY (US)

(21) Appl. No.: 12/241,989

(22) Filed: Sep. 30, 2008

(51) Int. Cl. G06Q 10/00

(52) U.S. Cl. 705/7

(57) ABSTRACT

Methods, systems and computer program products for inferential business process monitoring. Exemplary embodiments include an inferential business process monitoring method, including deriving an optimal set of key performance indicators from a service level agreement specification, determining metrics to compute the key performance indicators from the service level agreement specification, assigning and configuring monitoring agents to retrieve the metrics to obtain the key performance indicators, deploying the monitoring agents and delivering key performance indicator metrics observed by the monitoring agents.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field

This invention relates to key performance indicators and service level agreements, and particularly to inferential business process monitoring.

2. Background

Currently, to effectively observe key performance indicators (KPI) of executing business processes, a developer, such as a business analyst, determines the observation points of interest, develops monitoring rules, and configures monitoring engines. In particular, the business analyst can author a set of service level agreements (SLA). While there are software development tools available to the business analyst to author business processes, the SLAs are typically specified in natural language. Based on information specified in SLAs, the business analyst usually defines a set of KPIs. In addition, the business analyst typically provides the business process specification to developers to implement in software, for example. The developers must also interpret the SLAs and decide what events in the business process should be enabled so that the SLAs can be monitored. Often, though, developers activate all monitoring points (i.e., that emit monitoring events) for the business process, therefore affecting overall performance of the system. In parallel, the business analyst gives the SLAs to administrators who must also interpret the SLAs and, working together with the developers, write monitoring rules that collect the enabled business events, and compute the KPIs desired by the analyst.

This process has several drawbacks in that 1) the process requires developers and administrators, who normally lack deep understanding of business concepts, to understand business process and SLA concepts and 2) the process requires manual and error-prone and coordinated effort by developers and administrators.

### BRIEF SUMMARY

Exemplary embodiments include an inferential business process monitoring method, including deriving an optimal set of key performance indicators from a service level agreement specification, determining metrics to compute the key performance indicators from the service level agreement specification, assigning and configuring monitoring agents to retrieve the metrics to obtain the key performance indicators, deploying the monitoring agents and delivering key performance indicator metrics observed by the monitoring agents.

Additional exemplary embodiments include a computer program product including instructions for causing a computer to implement an inferential business process monitoring method, the method including deriving an optimal set of key performance indicators from a service level agreement specification, determining metrics to compute the key performance indicators from the service level agreement specification, assigning and configuring monitoring agents to retrieve the metrics to obtain the key performance indicators, deploying the monitoring agents and delivering key performance indicator metrics observed by the monitoring agents.

Further exemplary embodiments include an inferential business process monitoring system, including a processor, a library of generic monitoring agents operatively coupled to the processor, wherein the processor is configured for deriving an optimal set of key performance indicators from a service level agreement specification, determining metrics to compute the key performance indicators from the service level agreement specification, assigning and configuring monitoring agents to retrieve the metrics to obtain the key performance indicators, deploying the monitoring agents and delivering key performance indicator metrics observed by the monitoring agents.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### TECHNICAL EFFECTS

As a result of the summarized invention, technically a solution has been achieved which simplifies or eliminates the manual steps in monitoring KPIs by identifying and activating an optimal set of monitoring points that are needed to compute the KPIs specified in service level agreements (SLA), including identifying the monitoring metrics, developing the necessary rules, and optimizing the placement of these rules.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for inferential business process monitoring;

FIG. 2 illustrates a flow chart of a method for inferential business process monitoring in accordance with exemplary embodiments;

FIG. 3 illustrates the set of monitoring agents generated from a generic SLA in accordance with exemplary embodiments; and

FIG. 4 illustrates an Enterprise Service Bus having a deployed set of configured monitoring agents and rules in accordance with exemplary embodiments.

The detailed description explains the preferred embodiments of the invention, together with advantages and features, by way of example with reference to the drawings.

### DETAILED DESCRIPTION

In exemplary embodiments, the methods, systems and computer program products described herein 1) formalize SLAs during process modeling where the SLAs are best understood, 2) infer and activate required monitoring points for the business process, and 3) derive KPIs and generate monitoring rules. In exemplary embodiments, an extensible library of monitoring agents carries out the monitoring rules. In further exemplary embodiments, agents are deployed in a distributed manner as further described herein.

In exemplary embodiments, the methods, systems and computer program products described herein implement the observation that SLAs authored along with business processes contain the data and information needed to monitor KPIs of business processes. Furthermore, users often implement the monitoring of a process based on the associated SLAs. As such, by specifying SLAs in a formal language, as opposed to a natural language, the methods, systems and computer program products described herein automatically interpret SLAs and generate the monitoring rules. The manual steps to enable monitoring of business processes are thereby replaced with an automated process to automatically derive KPIs, activate an optimal set of monitoring points, select appropriate monitoring agents, configure and deploy the monitoring agents. Furthermore, the methods, systems and computer program products described herein automatically optimize the monitoring by distributing the monitoring workload and determining the appropriate placement of monitoring rules taking into account factors such as the system load and the volume of data being monitored. In exemplary embodiments, the methods, systems and computer program products described herein implement any suitable computing language for the formal SLA language. In examples described herein, Web Service Level Agreements (WSLA) are implemented as the formal SLA language.

The monitoring agents described herein are automatically generated by the SLA and are autonomous from the control of a central or global coordinator. Furthermore, the agents process the events and compute the SLA KPIs in a distributed manner. Runtime monitoring components (i.e., the monitoring agents) monitor themselves in addition to the system that the agents are monitoring. The runtime monitoring can be optimized with respect to user-defined criteria, such as minimizing the intrusiveness or overhead of monitoring. The runtime monitoring can be reconfigured without interruption. Runtime reconfiguration allows the monitoring subsystem to continuously adapt to environmental conditions without affecting the monitoring results.

In exemplary embodiments, with the methods, systems and computer program products described herein a business process can be automatically instrumented at implementation time to generate the events necessary for eventual runtime monitoring.

In exemplary embodiments, the methods, systems and computer program products described herein provide a decentralized architecture, which provides scalability for large volumes of data at process runtime.

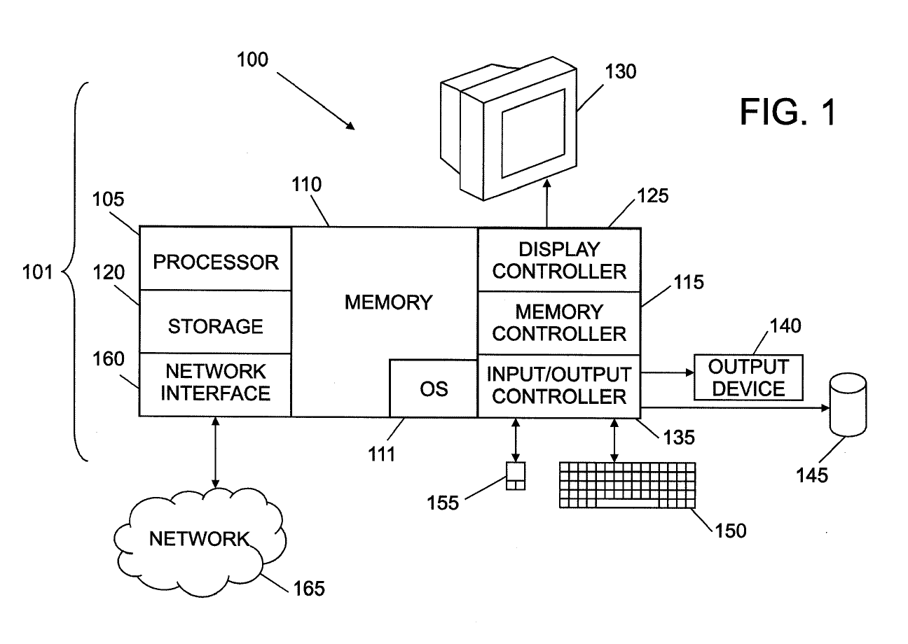

FIG. 1 illustrates an exemplary embodiment of a system 100 for inferential business process monitoring. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the inferential business process monitoring methods described herein in accordance with exemplary embodiments and a suitable operating system (OS) 111. The operating system 111 essentially controls the execution of other computer programs, such the inferential business process monitoring systems and methods described herein, and provides scheduling, input-output control, file and data management, memory management, and communication control and related services.

The inferential business process monitoring methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the inferential business process monitoring methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The inferential business process monitoring methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The inferential business process monitoring methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the inferential business process monitoring methods are implemented in hardware, the inferential business process monitoring methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

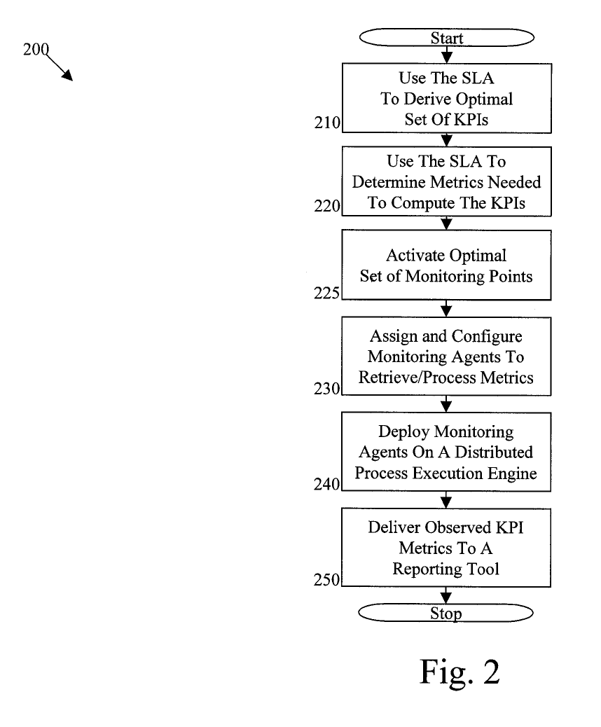

FIG. 2 illustrates a flow chart of a method for inferential business process monitoring in accordance with exemplary embodiments. At block 210, the system 100 derives the optimal set of KPIs from the SLA specification. The KPIs are those parameters in the SLA that are specified in a service level objective (SLO) whose violation requires some action (e.g., see Table 1 below). For example, in an SLA with an SLO that requires the number of invocations of a process to be within a defined threshold, the number of process invocations is inferred as a KPI. In exemplary embodiments, the SLA is associated with a process. In the SLA, there may be KPIs relevant to the service invoked by the process (i.e., the scope of the KPI being the invoked service), the entire process, or any portion of the process.

At block 220, the system 100 determines the metrics needed to compute the KPIs. In exemplary embodiments, both functional and non-functional metrics are enabled in the SLA. In exemplary embodiments, any KPIs that can be measured/monitored are considered. In exemplary embodiments, a formal SLA model is implemented in which the KPIs are specified such that the KPIs can be identified and monitored. The sources of the metrics to be observed may be heterogeneous and distributed, and may require an arbitrary number of stages of filtering and processing to compute the KPIs.

At block 225, this information is used to automatically activate an optimal set of monitoring points.

At block 230, the system 100 assigns and configures monitoring agents to retrieve the metrics or process them into higher level metrics, ultimately resulting in the KPIs. In exemplary embodiments, a library of generic monitoring agents performs various functions such as adding two measured values, or aggregating a stream of values. The appropriate agent is selected from the library based on the predicate types specified for each SLO. For example, in Table 1 the predicate type is “wsla:Less”, therefore an agent capable of evaluating less-than Boolean expression is selected. Since the agents in the library are generic, they also need to be configured for appropriate inputs, computation and outputs based on the SLA.

In exemplary embodiments, there are several components for each agent that are configured based on the SLA configuration. The agent components can include input, computation and output. In exemplary embodiments, the inputs to each agent are some (computed or observed) set of values used by the agent. Inputs that are the outputs of other agents are retrieved using automatically generated rules. For example, the output from metric agent ABC is retrieved with the rule [metric=ABC]. Inputs that are retrieved directly from an instrumentation point vary from agent to agent and must be specified in the SLA specification. For example, invocation counts of a service may be retrieved from a call to an administrative Web Service, or from an SNMP interface. In exemplary embodiments, the computation performed by the computation component is determined by the SLA. SLO agents compute the predicate expressed by the SLO and publish notifications in the event the SLO is violated. Metric agents perform the computation specified in the SLA, which include filtering or aggregating the input data. In exemplary embodiments, the output of each agent is determined by the SLA. SLO agents report violations of the SLO. Metric agents publish the results of their computation as specified in the SLA.

At block 240, the system 100 deploys the monitoring agents onto a distributed process execution engine that optimizes the placement of these rules. In this way, instead of gathering all monitoring data at a large central location and computing the KPIs, the monitoring computation, storage, and bandwidth load is distributed across the system.

At block 250, the system 100 delivers the observed KPI metrics to a reporting tool that would present the results to a user. It is appreciated that the several blocks described with respect to the method 200 can be executed in sequence as described. Furthermore, the blocks described herein can be executed in parallel

Table 1 illustrates a WLSA example in accordance with exemplary embodiments, illustrating a definition of service level objections (SLO).

TABLE 1
WSLA Example: Definition of Service Level Objective (SLO)

<ServiceLevelObjective name=“costSLO” ...>
<Obliged>provider</Obliged>
<Validity>
<StartDate>2007-04-01:1400</StartDate>
<EndDate>2008-04-01:1400</EndDate>
</Validity>
<Expression>
<Predicate xsi:type=“wsla:Less”>
<SLAParameter>CreditCheckCostPerDay</SLAParameter>
<Value>100</Value>
</Predicate>
</Expression>
<Optimize>Bandwidth</Optimize> <!-- Extension to WSLA -->
<EvaluationEvent>NewValue</EvaluationEvent>
</ServiceLevelObjective>

The example as outlined in Table 1 is now discussed. The SLA of Table 1 defines a Service Level Objective (SLO), which specifies that the cost of using an external service for the business process must be limited to less than $100 per day. Any SLAParameter used within the SLA is automatically inferred to be a KPI that is to be monitored by the system 100. In the example in Table 1, the KPI is the CreditCheckCostPerDay parameter. Based on SLO type (wsla:Less), a Boolean less-than agent is selected. In Table 2 below, the CreditCheckCostPerDay SLAParameter is based on the CreditCheckCostPerDay metric, which, in turn, is the sum of the creditCheck1CostPerDay and creditCheck2CostPerDay metrics. Another agent is configured with rules to retrieve the creditCheck1CostPerDay and creditCheck2CostPerDay metrics (from other agents in this case), and computes the sum of these values.

TABLE 2
WSLA Example: Metrics

<Metric name=“creditCheckCostPerDay” type=“float” unit=“dollars”>
<Source>provider</Source>
<Function xsi:type=“wsla:Plus” resultType=“float”>
<Operand> <Metric>creditCheck1CostPerDay</Metric> </Operand>
<Operand> <Metric>creditCheck2CostPerDay</Metric> </Operand>
</Function>
</Metric>
<Metric name=“creditCheck1CostPerDay” type=“float” unit=“dollars”>
<Source>provider</Source>
<Function xsi:type=“wsla:Multiply” resultType=“float”>
<Operand> <Metric>creditCheck1InvocationsPerDay</Metric>
</Operand>
<Operand> <LongScalar>0.01</LongScalar> </Operand>
</Function>
</Metric>
<Metric name=“creditCheck2CostPerDay” type=“float” unit=“dollars”>
...
</Metric>
<Metric name=“creditCheck1InvocationsPerDay” type=“integer”
unit=“invocations”>
<Source>provider</Source>
<Function xsi:type=“wsla:SumPerDay” resultType=“integer”>
<Metric>creditCheck1Invocation</Metric>
</Function>
</Metric>
<Metric name=“creditCheck1Invocation” type=“integer”
unit=“invocation”>
<Source>ms</Source> <!-- Note source -->
<MeasurementDirective xsi:type=“wsla:Invocation” resultType=“integer”>
<MeasurementURI> http://ms.com/invocation </MeasurementURI>
</MeasurementDirective>
</Metric>

In exemplary embodiments, MeasurementDirective elements within Metric elements specify how to retrieve metric values, such as by consuming events, querying a database, or invoking a service. For certain MeasurementDirective types, it is also possible to enable the instrumentation of the metric before runtime. For example, consider a MeasurementDirective type that consumes events generated by the process execution engine for one or more activities in the process. Referring again to FIG. 2, at block 225, the system 100 configures the execution engine to generate the appropriate events for the corresponding activity or activities.

The monitoring rules that determine the input, computation and output of a sample of the monitoring agents for the example SLA are shown in Table 3.

TABLE 3
Example WSLA: Monitoring Agents

| WSLA Entity | Generated Agent |
|---|---|
| SLO (costSLO) | Input: subscribe to [parameter = CreditCheckCostPerDay] |
| | Computation: CreditCheckCostPerDay < 100 |
| | Output: publish [SLO = costSLO] [result = violation] |
| Metric (creditCheckCostPerDay) | Input: subscribe to [metric = creditCheck1CostPerDay] |
| | Input: subscribe to [metric = creditCheck2CostPerDay] |
| | Computation: dailysum(creditCheck1CostPerDay, |
| | creditCheck2CostPerDay) |
| | Output: publish [metric = creditCheckCostPerDay] |
| | [value = xxx] |
| Metric (creditCheck1Invocation) | Input: callbacks from http://ms.com/invocation |
| | Computation: n/a |
| | Output: publish [metric = creditCheck1Invocation] |

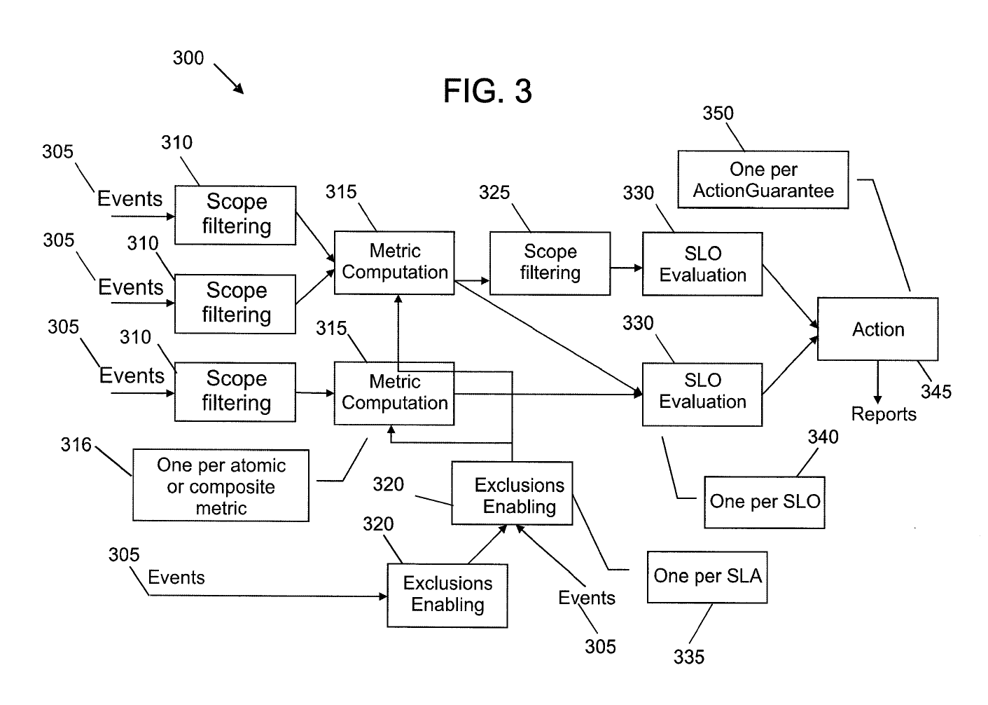

FIG. 3 illustrates the set of monitoring agents (and corresponding rules) generated from a generic SLA in accordance with exemplary embodiments. Scope filtering agents 310 receive a series of events 305 and forward or discard instrumented data (for example, discarding all non-VIP process invocations) to metric computation agents 315, which directly correspond to Metric elements in a WSLA specification, for data processing (for example, aggregating process invocations into an hourly average). In exemplary embodiments, there is one metric computation per atomic or composite metric, generally referred to as label 316. Alternatively an exclusions enabling agent 320 can receive the events 305 for excluding certain events. Similarly, the exclusions enabling agents 320 can receive an output of the metric computations agents 315 for exclusion of certain characteristics of the output of the metric computations agents 315. In exemplary embodiments, there can be one exclusion per SLA 335. Scope filtering agents 325 can receive output from the metric computation agents 315 to provide filtering of the scope of the metric computations. SLO evaluation agents 330 can receive output from the metric computation agents 315 and the scope filtering agents 325 for generating KPIs and passing the output to action agents 345 for generating reports. In exemplary embodiments, there is one SLO evaluation agent per SLO 340. In addition, there is one action agent per action guarantee 350. As such, agents can also be configured to enable and disable the SLA based on runtime conditions such as the time of day load characteristics. In addition, the SLO evaluation and action agents 330, 345 are generated to compute KPIs and report SLA violations, respectively.

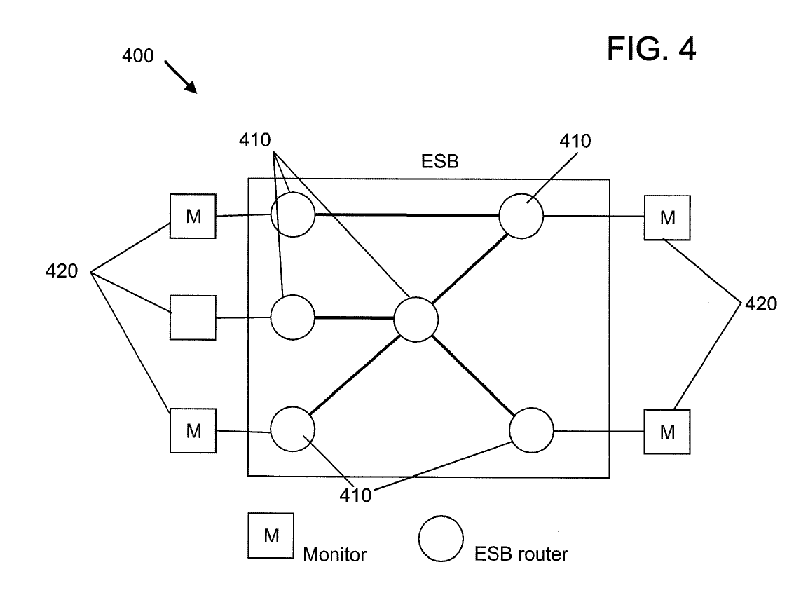

The set of configured monitoring agents and rules are deployed across an Enterprise Service Bus (ESB) 400 as pictured in FIG. 4. The ESB 400 can include a series of ESB routers 410 that are monitored by monitoring agent 420. As such, the monitoring agents 40 are automatically and dynamically deployed to the optimal locations in the system based on optimization criteria (such as minimizing the monitoring bandwidth overhead) and load conditions.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An inferential business process monitoring method, comprising:
deriving an optimal set of key performance indicators via a service level agreement;
determining metrics to compute the key performance indicators via the service level agreement;
assigning and configuring monitoring agents to retrieve the metrics to obtain the key performance indicators;
deploying the monitoring agents; and
delivering key performance indicator metrics observed by the monitoring agents.

2. The method as claimed in claim 1 wherein the key performance indicators are parameters in the service level agreement that are specified in a service level objective, a violation of which requires an action.

3. The method as claimed in claim 1 further comprising processing sources of the metrics to compute the key performance indicators.

4. The method as claimed in claim 3 further comprising activating an optimal set of monitoring points via processed sources of the metrics.

5. The method as claimed in claim 1 further comprising processing the metrics into higher level metrics to obtain the key performance indicators.

6. The method as claimed in claim 1 further comprising selecting the monitoring agents from a library of generic monitoring agents.

7. The method as claimed in claim 6 further comprising configuring the monitoring agents for an input, computation and output based on the service level agreement.

8. The method as claimed in claim 1 wherein the monitoring agents are deployed onto a distributed process execution engine that optimizes the placement of the monitoring agents, which include monitoring rules.

9. A computer program product including instructions for causing a computer to implement an inferential business process monitoring method, the method comprising:
deriving an optimal set of key performance indicators via a service level agreement;
determining metrics to compute the key performance indicators via the service level agreement;
assigning and configuring monitoring agents to retrieve the metrics to obtain the key performance indicators;
deploying the monitoring agents; and
delivering key performance indicator metrics observed by the monitoring agents.

10. The computer program product as claimed in claim 9 wherein the key performance indicators are parameters in the service level agreement, which are specified in a service level objective, a violation of which requires an action.

11. The computer program product as claimed in claim 9 wherein the method further comprises processing sources of the metrics to compute the key performance indicators.

12. The computer program product as claimed in claim 11 wherein the method further comprises activating an optimal set of monitoring points via processed sources of the metrics.

13. The computer program product as claimed in claim 9 wherein the method further comprises processing the metrics into higher level metrics to obtain the key performance indicators.

14. The computer program product as claimed in claim 9 wherein the method further comprises selecting the monitoring agents from a library of generic monitoring agents.

15. The computer program product as claimed in claim 14 wherein the method further comprises configuring the monitoring agents for an input, computation and output based on the service level agreement.

16. The computer program product as claimed in claim 9 wherein the monitoring agents are deployed onto a distributed process execution engine that optimizes the placement of rules associated with the monitoring agents.

17. An inferential business process monitoring system, comprising:
a processor;
a library of generic monitoring agents operatively coupled to the processor, wherein the processor is configured for:
deriving an optimal set of key performance indicators via a service level agreement;
determining metrics to compute the key performance indicators via the service level agreement;
assigning and configuring monitoring agents to retrieve the metrics to obtain the key performance indicators;
deploying the monitoring agents; and
delivering key performance indicator metrics observed by the monitoring agents.

18. The system as claimed in claim 17 wherein the processor is further configured for selecting the monitoring agents from the library of generic monitoring agents.

19. The system as claimed in claim 18 wherein the process is further configured configuring the monitoring agents for an input, computation and output based on the service level agreement.

20. The system as claimed in claim 17 wherein the monitoring agents are deployed onto a distributed process execution engine that optimizes the placement of rules associated with the monitoring agents.
